(19) United States
(12) Patent Application Publication
(10) Pub. No.: US 2024/0005177 A1
(43) Pub. Date: Jan. 4, 2024

(54) MONITORING PERFORMANCE OF TIME SERIES PREDICTION MODELS

(71) Applicant: Amazon Technologies, Inc., Seattle, WA (US)

(72) Inventors: Adarsh Singh, Seattle, WA (US); Rajendra Kumar Vippagunta, Issaquah, WA (US); Jitendra Bangani, Kirkland, WA (US); Namita Das, Seattle, WA (US); Xiufeng Zhao, Bellevue, WA (US); Narayan Agrawal, Mill Creek, WA (US)

(73) Assignee: Amazon Technologies, Inc., Seattle, WA (US)

(21) Appl. No.: 17/810,297

(22) Filed: Jun. 30, 2022

(51) Int. Cl. G06N 5/02

(52) U.S. Cl. CPC G06N 5/022

(57) ABSTRACT

Monitoring may be performed for time series prediction models. Data to generate a new time series forecast may be received. A determination may be made that the data is associated with a previously generated time series forecast by a machine learning model. Performance metrics may be generated for the machine learning model according to a comparison of the data with the previously generated time series forecast. The performance metrics can then be provided for further analysis and action.

### BACKGROUND

Machine learning models are increasingly used in various applications. Different types of data, such as time series data, may be used to create machine learning models. Moreover, the data used to train machine learning models may change over time. Therefore, different techniques for selecting how to account for the changes to the data used to train machine learning models may also be utilized.

### BRIEF DESCRIPTION OF THE DRAWINGS

FIG. 1 illustrates a logical block diagram of monitoring time series model prediction performance, according to some embodiments.

FIG. 2 illustrates an example provider network that may implement a time series forecasting service that may implement monitoring time series model prediction performance, according to some embodiments.

FIG. 3 illustrates a logical block diagram illustrating model monitoring, according to some embodiments.

FIG. 4 illustrates interactions between a client and a time series forecasting service, according to some embodiments.

FIG. 5 illustrates an example graphical user interface for model monitoring, according to some embodiments.

FIG. 6 illustrates a high-level flowchart of various methods and techniques to implement monitoring time series model prediction performance, according to some embodiments.

FIG. 7 illustrates a high-level flowchart of various methods and techniques to implement detecting and performing responsive actions based on time series prediction model performance, according to some embodiments.

FIG. 8 illustrates an example system to implement the various methods, techniques, and systems described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION OF EMBODIMENTS

Various techniques of monitoring time series model prediction performance are described herein. Time series, which may describe various actions, events, or other data points corresponding to points in time, may offer valuable insights into the performance of various systems, services, applications, or organizations. Predictions of future time series data, sometimes referred to as forecasts, based on time series data may allow for these systems, services, applications, or organizations to anticipate, plan, respond, or otherwise act in ways to prepare for future events indicated by the predictions.

Time series forecasts may impact business decisions of organizations around the globe, from retail and financial services to autonomous vehicles and space exploration. For these organizations, training and deploying machine learning models into production is an integral part of achieving various business goals, including various systems, services, or applications that rely upon or utilize forecasts generated by these machine learning models. However, machine learning model performance may degrade over time for several reasons, such as changing consumer purchase patterns in the retail industry, changing economic conditions in the financial industry, or various other factors that cause changes in collected time series data. Thus, degrading model quality has a negative impact on the systems, services, or applications that utilize these forecasts. To proactively address this problem, monitoring the performance of a deployed machine learning model that generates forecasts may be implemented in various embodiments.

Monitoring of model performance in production environments supports governance of machine learning models. Real world data is constantly changing, and so is the use of this data when it is collected to build or utilize machine learning models that generate time series forecasts. When a deployed machine learning model is not behaving the same way as it was during the training phase, then this scenario may be identified as model drift. Many factors may be responsible for model drift, such as bias in sampling data that affects features or label data, non-stationary nature of time series data, or changes in a data pipeline or external factors, such as changes in usage patterns.

Early and proactive detection of model drift may enable users to take corrective actions like retrain machine learning models, auditing upstream systems for data quality or incorporate more features to improve a current machine learning model. While some techniques impose manual monitoring burdens for monitoring model performance for drift which is time consuming, or techniques may skip monitoring altogether and can do retraining every time new data is obtained in expectation that the machine learning model will learn from the latest trend. Such techniques are inefficient and could still lead to poor performance if there is a change or issue with the data. Therefore, as discussed in detail below, techniques for monitoring time series model prediction performance may be implemented in some embodiments that can implement monitoring of model performance without imposing burdensome development tasks. Instead, centralized monitoring and detection of degradation or other performance changes can be implemented as these changes can be detected when new time series data is received, integrating the arrival of new time series data with monitoring techniques directly. Such techniques avoid inefficient manual techniques but still can determine the effect of new data before making costly machine learning model changes, such as retraining the machine learning model, and can also identify upstream problems (e.g., in data collection for time series data) that might otherwise go undetected.

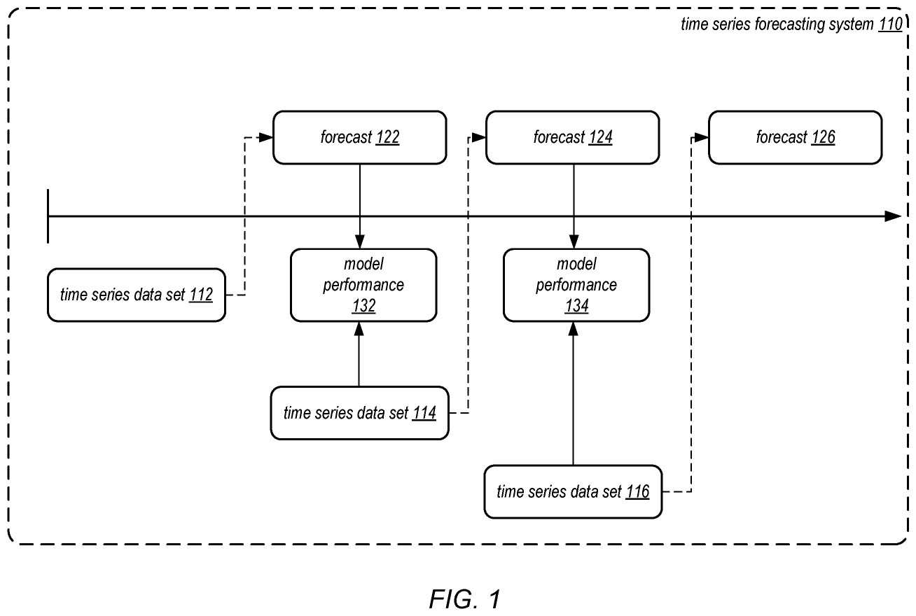

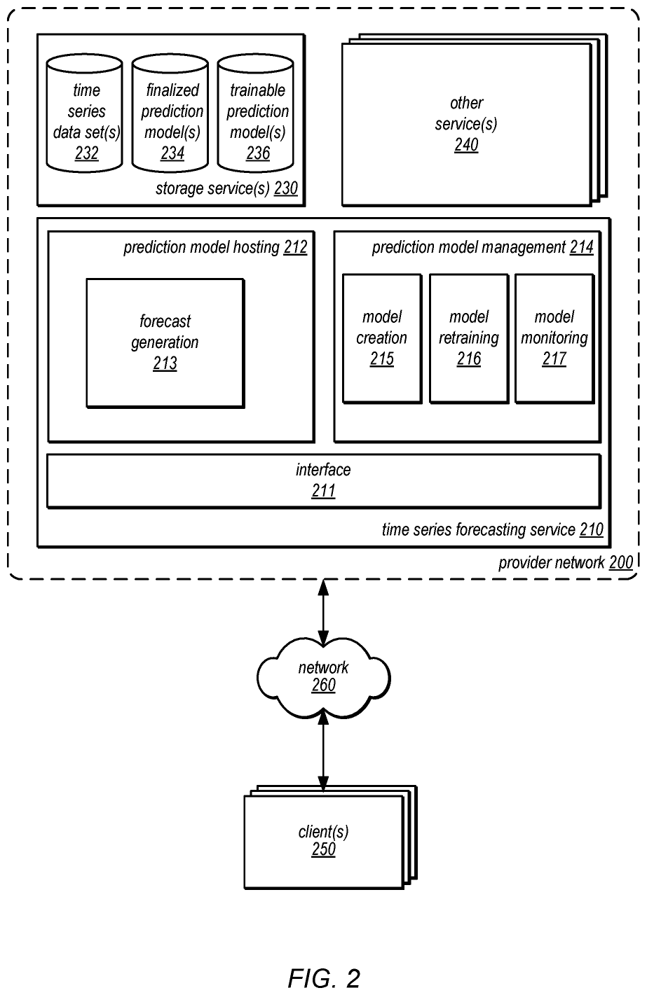

FIG. 1 illustrates a logical block diagram of monitoring time series model prediction performance, according to some embodiments. Time series forecasting system 110 may be implemented as a standalone system or application (e.g., as part of a container or virtual machine image that can be executed on host systems, either private host systems or virtual compute services of a provider network, like provider network 200 discussed below with regard to FIG. 2) or as part of a service, such as time series forecasting service 210 discussed below with regard to FIG. 2.

Time series forecasting system 110 may implement monitoring for the performance of a machine learning model that generates time series forecasts using received data sets for future forecasts. For example, time series data set 112 may be used to generate forecast 112. When time series data set 114 is received to generate forecast 124, time series forecasting system 110 may also use time series data set 114 to generate model performance information 132 with forecast 122 as part of a monitoring process. In this way, the arrival of new time series data can trigger the update of performance information and can over time build a picture of the machine learning model's performance for generating forecasts as these techniques can be repeated for subsequent arrivals of time series data to generate other time series forecasts. For instance, the technique may be applied with respect to time series data set 116 received for forecast 126, which may be used to generate model performance 134 with forecast 124.

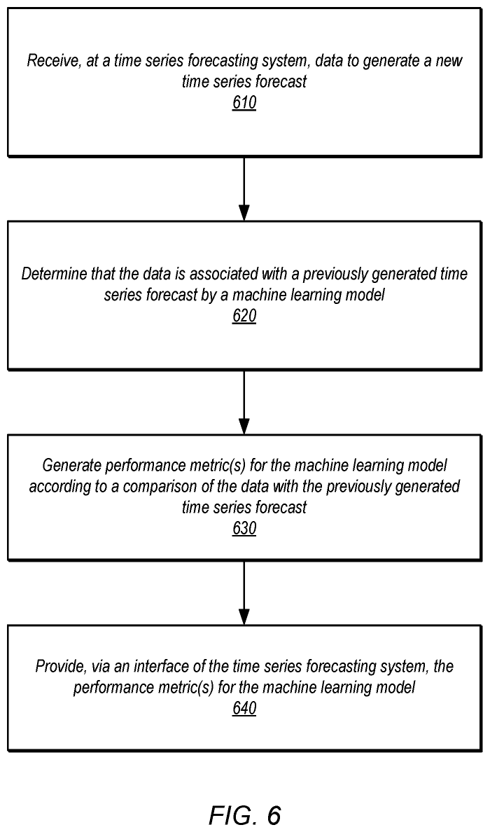

As model performance information, such as model performance 132 and 134, is collected over time various notification, alerting, analyses, and remediation actions may be taken, as discussed in detail below with regard to FIG. 6. For example, model performance can be used to detect degradation in model performance to trigger an alert for a user, which may allow for an investigation into the upstream data collection process for time series data (e.g., to identify an error or other modification that causes a change in the way values in the time series are determined). Note that various other responsive actions based on an analysis of model performance may be performed and that the previous discussion is merely provided as an example of one such responsive action.

Please note that the previous description of a time series forecasting system is a logical illustration and thus is not to be construed as limiting as to the implementation of time series forecasting systems and incremental retraining techniques.

This specification begins with a general description of a provider network that implements multiple different services, including a time series forecasting service that may implement monitoring time series model prediction performance. Then various examples of the time series forecasting service, including different components/modules, or arrangements of components/module that may be employed as part of implementing the time series forecasting service are discussed. A number of different methods and techniques to implement monitoring time series model prediction performance are then discussed, some of which are illustrated in accompanying flowcharts. Finally, a description of an example computing system upon which the various components, modules, systems, devices, and/or nodes may be implemented is provided. Various examples are provided throughout the specification.

FIG. 2 illustrates an example provider network that may implement a time series forecasting service that may implement monitoring time series model prediction performance, according to some embodiments. Provider network 200 may be a private or closed system, or may be set up by an entity such as a company or a public sector organization to provide one or more services (such as various types of cloud-based storage) accessible via the Internet and/or other networks to clients 250, in one embodiment. Provider network 200 (which may, in some implementations, be referred to as a “cloud provider network” or simply as a “cloud”) refers to a pool of network-accessible computing resources (such as compute, storage, and networking resources, applications, and services), which may be virtualized or bare-metal. Provider network 200 can provide convenient, on-demand network access to a shared pool of configurable computing resources that can be programmatically provisioned and released in response to customer commands. These resources can be dynamically provisioned and reconfigured to adjust to variable load. For example, in some embodiments, provider network 200 may implement various computing resources or services, such as time series forecasting service 210, storage service(s) 230, and/or any other type of network-based services 240 (which may include a virtual compute service and various other types of storage, database or data processing, analysis, communication, event handling, visualization, data cataloging, data ingestion (e.g., ETL), and security services), in some embodiments.

The provider network 200 can be formed as a number of regions, where a region is a separate geographical area in which the cloud provider clusters data centers. Each region can include two or more availability zones connected to one another via a private high speed network, for example a fiber communication connection. An availability zone (also known as an availability domain, or simply a “zone”) refers to an isolated failure domain including one or more data center facilities with separate power, separate networking, and separate cooling from those in another availability zone. Preferably, availability zones within a region are positioned far enough away from one other that the same natural disaster should not take more than one availability zone offline at the same time. Customers can connect to availability zones of the provider network 200 via a publicly accessible network (e.g., the Internet, a cellular communication network). Regions are connected to a global network which includes private networking infrastructure (e.g., fiber connections controlled by the cloud provider) connecting each region to at least one other region. The provider network 200 may deliver content from points of presence outside of, but networked with, these regions by way of edge locations and regional edge cache servers. This compartmentalization and geographic distribution of computing hardware enables the provider network 200 to provide low-latency resource access to customers on a global scale with a high degree of fault tolerance and stability.

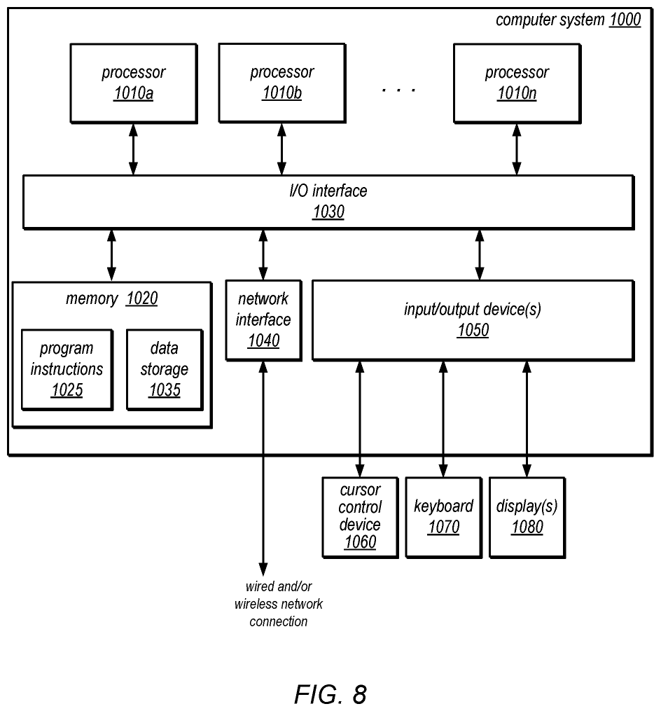

In various embodiments, the components illustrated in FIG. 2 may be implemented directly within computer hardware, as instructions directly or indirectly executable by computer hardware (e.g., a microprocessor or computer system), or using a combination of these techniques. For example, the components of FIG. 2 may be implemented by a system that includes a number of computing nodes (or simply, nodes), each of which may be similar to the computer system embodiment illustrated in FIG. 8 and described below, in one embodiment. In various embodiments, the functionality of a given system or service component (e.g., a component of machine learning model-based search service 210 may be implemented by a particular node or may be distributed across several nodes. In some embodiments, a given node may implement the functionality of more than one service system component (e.g., more than one data store component).

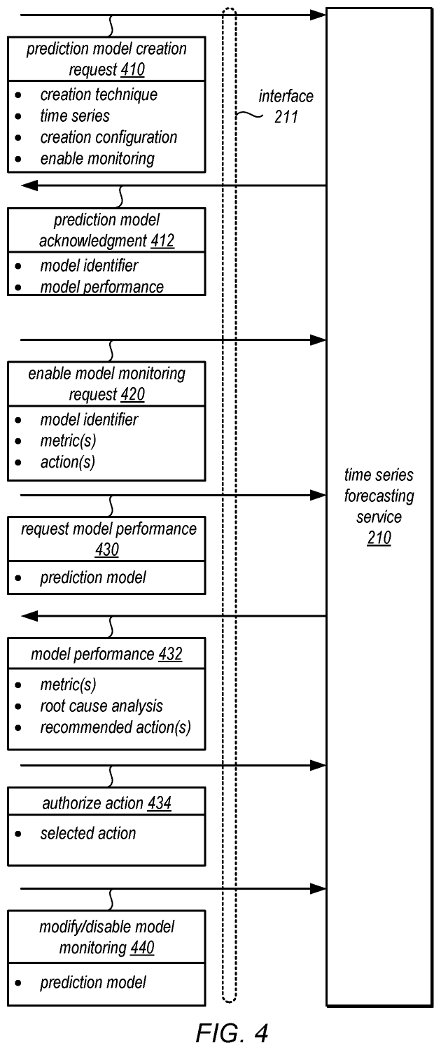

Time series forecasting service 210 may implement interface 211 to allow clients (e.g., client(s) 250 or clients implemented internally within provider network 200, such as a client application hosted on another provider network service like an event driven code execution service or virtual compute service) to send request to create a prediction model (e.g., using specific creation techniques or using automatically selected creation techniques as discussed in detail below), retrain a prediction using incremental retraining techniques, or obtain a prediction using a prediction model. For example, time series forecasting service 210 may implement interface 211 (e.g., a graphical user interface, programmatic interface that implements Application Program Interfaces (APIs) and/or a command line interface) may be implemented so that a client can request submit various requests, including the various requests as discussed in detail below with regard to FIG. 4.

Time series forecasting service 210 may implement prediction model hosting 212, in various embodiments. Prediction model hosting 212 may provision (or implement) computing resources (e.g., compute instances, containers, servers, etc.) to host created prediction models in order to respond to requests for forecasts for item(s) in a time series using the hosted prediction model. These computing resources may implement forecast generation 213 to handle requests directed to identified prediction models, applying a hosted prediction model identified in a request, such as one of finalized prediction model(s) 234, created from a provided set of time series to generate various inferences or other predications (e.g., forecasts) of future values for items in the time series. These predictions may be returned in text (e.g., in files, such as Comma Separated Values (CSV) files), via a programmatic interface (e.g., to be incorporated into other applications to use forecast results) and/or using various visualization techniques (e.g., graph displays). Different quantiles may be selected and various other features for specifying the generation of a forecast, in some embodiments.

Time series forecasting service 210 may implement prediction model creation 214. Prediction model management 214 may create and update machine learning models to provide predictions of future time series data as forecasts. In some embodiments, prediction model management 214 may implement model creation 215. Model creation 215 may support manually requested prediction model creation, where a client specifies via a creation request the creation technique to use for creating a prediction model. In some embodiments, model creation 215 may be automated. Automatic model creation may include selecting one (or more) creation techniques to use to create a prediction model by creating different candidate versions of the prediction model and comparing prediction model performance (e.g., selecting a most accurate model according to various accuracy measures as discussed below).

Different types of prediction model creation techniques may be supported. For example, both trained creation techniques, such as Convolutional Neural Network (CNN) based creation techniques, such as ones that use perform quantile regression using a causal CNN and Recurrent Neural Network (RNN) based creation technique that uses a RNN to provide a prediction model, and non-trained creation techniques may also be supported and considered for selection, such as additive model-based forecasting techniques where non-linear trends are fit with different time periods of seasonality (e.g., yearly, weekly, and daily), scalable, probabilistic baseline forecaster to handle time series data which may be sparse or intermittent (e.g., including different various for different types of features, such as seasonal, climatological, and a combination of seasonal and climatological), Autoregressive Integrated Moving Average (ARIMA), and Exponential Smoothing (ETS) (e.g., computing a weighted average over all observations in the time series dataset as its prediction, with exponentially decreasing weights over time). Please note that other time series prediction model creation techniques may be implemented in other embodiments in addition to the above examples or instead of the above examples. In some embodiments, automatic model creation may test all available creation techniques, and in other embodiments the selection of a subset of creation techniques may be performed to create candidates using some available creation techniques which can then be evaluated to select a best prediction model based on respective performance.

Model retraining 216 may perform various retraining techniques including full or incremental retraining. In some embodiments, retraining may be performed in response to various client requests, such as a retraining request. In some embodiments, various automatic retraining events may also be used in addition to manually requested retraining in order to automatically manage the lifecycle of a prediction model (e.g., as a responsive action with regard to detected model drift). In some embodiments, full retraining may be handled like create prediction model requests using a time series that includes any additional time series data as part of the time series used as training data. Incremental retraining techniques may perform partial training of a machine learning model and may include techniques like hyperparameter determination which may, for example, determine the hyperparameters used to create the trainable prediction model and/or perform back testing which may split time series data into a training and testing set according to different offset windows in order to determine performance for a prediction model updated according to an incremental retraining technique.

Data storage service(s) 230 may implement different types of data stores for storing, accessing, and managing data on behalf of clients 250 as a network-based service that enables clients 250 to operate a data storage system in a cloud or network computing environment. Data storage service(s) 230 may also include various kinds relational or non-relational databases, in some embodiments. Data storage service(s) 230 may include object or file data stores for putting, updating, and getting data objects or files, in some embodiments. For example, one data storage service 230 may be an object-based data store that allows for different data objects of different formats or types of time series data set(s) 232, which may be accessed by and used for time series forecasting service 210. For example, various data gathering systems, client uploads, or other techniques for placing time series data into storage services 230 may be performed, such as a client that performs monthly uploads of time series data for a corresponding month as a new fil or data object to add to a collection of files or data objects that make up time series data set(s) 232. In some embodiments, finalized prediction model(s) 234 and trainable prediction models 236 generated by time series forecasting service 210 may be stored in storage service(s) 230. In at least some embodiments, data storage service(s) 230 may be treated as a data lake. For example, an organization may generate many different kinds of data, stored in one or multiple collections of data objects in a data storage service 230. The data objects in the collection may include related or homogenous data objects, such as database partitions of sales data, as well as unrelated or heterogeneous data objects, such as image data files (e.g., digital photos or video files) audio files and web site log files. Data storage service(s) 230 may be accessed via programmatic interfaces (e.g., APIs) or graphical user interfaces.

Generally speaking, clients 250 may encompass any type of client that can submit network-based requests to provider network 200 via network 260, including requests for time series forecasting service 210 (e.g., a request to retrain a prediction model for a time series, etc.). For example, a given client 250 may include a suitable version of a web browser, or may include a plug-in module or other type of code module that can execute as an extension to or within an execution environment provided by a web browser. Alternatively, a client 250 may encompass an application such as an application that may make use of time series forecasting service 210 to implement various applications. For example, a client 250 may utilize a prediction model 234 hosted deployed by prediction model hosting 212 in order to obtain a forecast of time series data, which may be sent via interface 211. In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 250 may be an application that can interact directly with provider network 200. In some embodiments, client 250 may generate network-based services requests according to a Representational State Transfer (REST)-style network-based services architecture, a document- or message-based network-based services architecture, or another suitable network-based services architecture.

In some embodiments, a client 250 may provide access to provider network 200 to other applications in a manner that is transparent to those applications. Clients 250 may convey network-based services requests (e.g., access requests to read or write data may be via network 260, in one embodiment. In various embodiments, network 260 may encompass any suitable combination of networking hardware and protocols necessary to establish network-based-based communications between clients 250 and provider network 200. For example, network 260 may generally encompass the various telecommunications networks and service providers that collectively implement the Internet. Network 260 may also include private networks such as local area networks (LANs) or wide area networks (WANs) as well as public or private wireless networks, in one embodiment. For example, both a given client 250 and provider network 200 may be respectively provisioned within enterprises having their own internal networks. In such an embodiment, network 260 may include the hardware (e.g., modems, routers, switches, load balancers, proxy servers, etc.) and software (e.g., protocol stacks, accounting software, firewall/security software, etc.) necessary to establish a networking link between given client 250 and the Internet as well as between the Internet and provider network 200. It is noted that in some embodiments, clients 250 may communicate with provider network 200 using a private network rather than the public Internet.

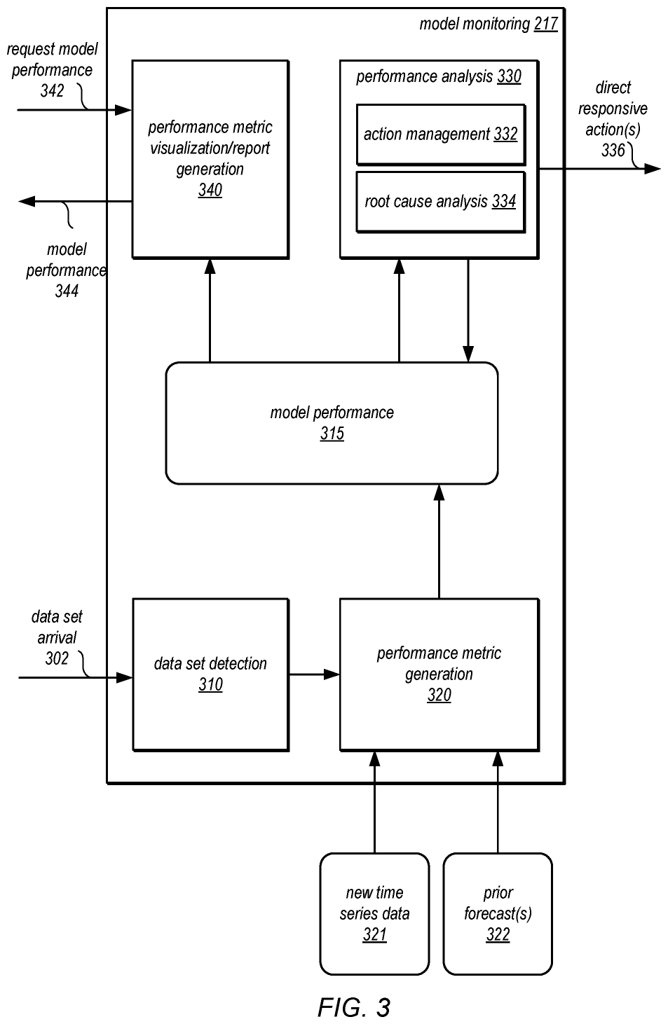

As part of prediction model management 214, model monitoring 217 may be implemented in order to handle various scenarios in which retraining of a prediction model may be performed. FIG. 3 illustrates a logical block diagram illustrating model monitoring, according to some embodiments.

Data set detection 310 may be able to determine when new data sets arrive at time series forecasting service, as indicated at 302. For example, a notification or trigger of the new data set's arrival that initiates performance metric generation 320 may be provided or otherwise received. Data set detection 310 may then initiate an update process for model performance 315, notification performance metric generation 320 of the new data set. In some embodiments, a data set may be applicable to multiple machine learning models that generate different forecasts using the data set (e.g., forecasts at different resolutions). Data set detection 310 may initiate different model performance updates for model performance 315 for other machine learning models. In this way, a single data set's arrival 302 can trigger multiple machine learning model updates.

Performance metric generation 320 may then obtain new time series data 321. For example, the notification of data set arrival The new time series data 321 may be obtained as well as one or more prior forecast(s) 322. Performance metric generation 320 may perform the various comparisons to generate the performance metrics and update model performance 315. For example, as discussed in detail below various performance metrics may include, but are not limited to, Root Mean Square Error (RMSE), Weighted Quantile Loss (wQL), Weighted Absolute Percentage Error (WAPE), Mean Absolute Percentage Error (MAPE), and Mean Absolute Scaled Error (MASE).

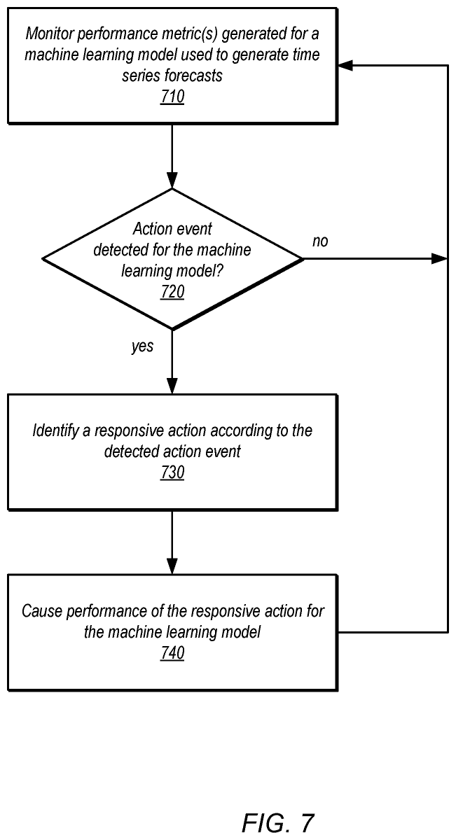

In various embodiments, model monitoring 217 may implement performance analysis 330 to coordinate the analysis and actions with respect to model performance 315. For example, performance analysis 330 may implement action management 332. Action management 332 may apply various action event detection criteria to detect and direct responsive actions 336, as also discussed below with regard to FIG. 7. Performance analysis 330 may also implement root cause analysis 334, which may evaluate changes in performance metrics from model performance 315 to identify causes for the changes (e.g., additional data types, seasonality patterns, anomalies, etc.). In some embodiments, machine learning models may be trained to implement root cause analysis 334 (e.g., having been trained to classify one or more cause classifications for a time series machine learning model given, for instance, the performance metrics collected for the machine learning model). In other embodiments, a rules-based root cause analysis may be implemented to classify root causes according to different heuristics applicable to identify different root causes.

Performance metric visualization and report generation 340 may obtain model performance 315 and produce various reports and visualizations (e.g., graphs, such as histograms or line graphs, plots, or other representations of performance metrics, such as heat maps). Performance metric visualization and report generation 340 may produce these features from the metrics stored in model performance 315 in response to requests for performance 342 and provide them in response, as indicated at 344.

FIG. 4 illustrates interactions between a client and a time series forecasting service, according to some embodiments. For example, interface 211 may support a prediction model creation request 410. Request 410 may include one some or all of the various example parameters, such as an indication of the creation technique to use (or to use an automated selection technique that generates different candidate prediction models using different creation techniques and then selects a best performing one as the prediction model), the identity of a time series to use for model creation, performance characteristics and/or other creation configuration (e.g., optimize for accuracy, speed, etc.), as well as other features, such as including weather and/or seasonality information for prediction models, forecast types (e.g., quantiles), and number of time-steps to predict. In some embodiments, monitoring information may be included, such as enabling automatic model monitoring for various metrics and, in some embodiments, authorizing performance of responsive actions in response to action criteria (which may also be specified) for various events. As indicated at 512, an acknowledgement may also be provided that indicates that the prediction model is created. A prediction model identifier (e.g., a unique identifier, name, location, path, or other identifier) may be provided. In some embodiments, various model performance information, such as various performance metrics may be provided, including, but limited to, Root Mean Square Error (RMSE), Weighted Quantile Loss (wQL), and Weighted Absolute Percentage Error (WAPE) metrics generated by performing one or more backtests.

As indicated at 420, a separate request to enable monitoring may be received (e.g., for an already created machine learning model). This request may include information such as the model identifier, selected metrics to monitor for and, in some embodiments, respective action(s) to take in certain events (e.g., according to specified event criteria, such as one or more metric thresholds triggering various responsive actions, including notification or remedial actions).

As indicated at 430, a request for model performance may be made, specifying the prediction model identifier. In some embodiments, a response of model performance 432 may be sent, which may include the performance metrics, root cause analysis results, and/or recommended actions. As indicated at 434, a response selecting an action and providing authorization may be made.

As indicated at 440, a request to disable or modify the monitoring of a machine learning model may be received, in some embodiments. Such a request may include the prediction model identifier. Acknowledgement may be provided in response (not illustrated). Modification may include one or more features of model monitoring to change, such as the authorization for responsive actions and/or the event criteria to detect them.

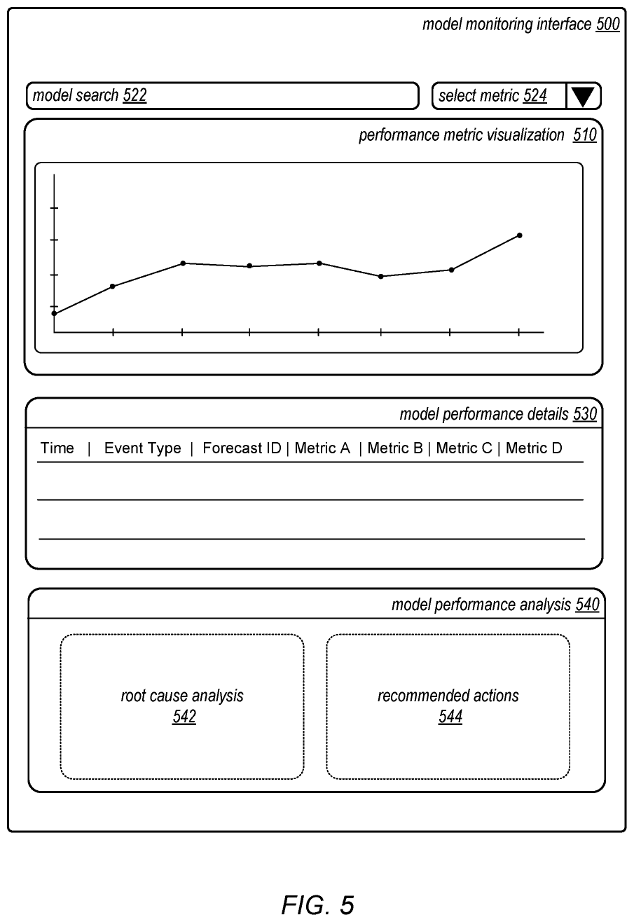

FIG. 5 illustrates an example graphical user interface for model monitoring, according to some embodiments. Model monitoring interface 500 may implement various types or combinations of user elements to display or provide performance information and analysis. For example, model search element 522 may be implemented to provide a search interface to locate and select a machine learning model for performance information. Metric selection element 524 may be used to select one of the generated performance metrics for display as part of performance metric visualization 510. Details of the model's performance may be displayed, as illustrated at 530. The results of model performance analysis 540, including root cause analysis for various changes in performance metrics, as indicated at 542, and/or recommended action(s) 544 to take, such as incremental retraining or a full retraining may be specified. Note that FIG. 5 is provided for exemplary purposes and may not be construed as limiting the arrangement or form of various user interface elements and/or visualizations that may be provided in other scenarios or embodiments. For example, performance metric visualization 510 may be able to overlay various different performance metrics observed at initial model creation versus a current performance.

Although FIGS. 2-5 have been described and illustrated in the context of a provider network implementing a time series forecasting service, the various components illustrated and described in FIGS. 2-4 may be easily applied to other systems that utilize time series forecasting or training prediction models for time series forecasting. As such, FIGS. 2-5 are not intended to be limiting as to other embodiments of monitoring time series model prediction performance.

FIG. 6 illustrates a high-level flowchart of various methods and techniques to implement monitoring time series model prediction performance, according to some embodiments. Different systems and devices may implement the various methods and techniques described below, either singly or working together. Therefore, the above examples and or any other systems or devices referenced as performing the illustrated method, are not intended to be limiting as to other different components, modules, systems, or devices.

As indicated at 610, data may be received for generating a new time series forecast, in some embodiments. For example, the time series data may be received as part of a request to generate the new time series forecast. In some embodiments, the data may be received as part of a data pipeline or other automated data collection system. Receipt of the time series data may trigger a determination as to which machine learning models rely upon the time series data to generate forecasts as, in some embodiments, multiple models may rely upon the same time series (e.g., but generate different types of forecasts). Thus, the techniques for updating one machine learning model may be also performed (e.g., in parallel) for other machine learning models that utilize the same time series data (even if these machine learning models have different forecast goals).

As indicated at 620, a determination may be made that the data is associated with a previously generated time series forecast by a machine learning model, in some embodiments. For example, mapping information may be maintained that links time series data for a time series with one (or more) machine learning models that generate forecasts from that time series data.

As indicated at 630, one or more performance metric(s) may be generated for the machine learning model according to a comparison of the data with the previously generated time series forecast, in some embodiments. Such metrics may include, but are not limited to, Root Mean Square Error (RMSE), Weighted Quantile Loss (wQL), and Weighted Absolute Percentage Error (WAPE), Mean Absolute Percentage Error (MAPE), and Mean Absolute Scaled Error (MASE). In some embodiments, custom metrics may be supported. For instance, a custom metric may be specified using a defined function, operation, or task that can be executed on another system, application or service (e.g., a virtual compute service of a provider network may provide on-demand execution of a specified function by submitting a request invoking function performance to a network endpoint, which may then return a response with the custom metric).

As indicated at 640, the performance metric(s) for the machine learning model may be provided via an interface for the time series forecasting system, in some embodiments. As discussed above with regard to FIGS. 3 and 5, visualizations of the performance metrics may be provided, as well as various other analysis results, such as recommended actions or root causes of the performance metrics, as discussed above with regard to FIGS. 3 and 4.

FIG. 7 illustrates a high-level flowchart of various methods and techniques to implement detecting and performing responsive actions based on time series prediction model performance, according to some embodiments.

As indicated at 710, performance metric(s) generated for a machine learning model used to generate time series forecasts may be monitored, in some embodiments. Different criteria corresponding to different actions may be evaluated with respect the performance metrics. As indicated by the positive exit from 720, an action event may be detected, in some embodiments.

As indicated at 730, a responsive action may be identified according to the action event, in some embodiments. For example, different criteria for sending alerts, via various communication systems (e.g., email, mobile device message, displayed alert on console, messaging or notification system, etc.). In some embodiments, other responsive actions can include changing or effecting the performance of the machine learning model, such as causing the machine learning model to be retrained (e.g., including data received that was used to determine the performance metric(s)).

As indicated at 740, performance of the responsive actions for the machine learning model may be caused, in some embodiments. For example, various API requests or other operations may be started to perform the responsive action, in some embodiments.

The methods described herein may in various embodiments be implemented by any combination of hardware and software. For example, in one embodiment, the methods may be implemented on or across one or more computer systems (e.g., a computer system as in FIG. 8) that includes one or more processors executing program instructions stored on one or more computer-readable storage media coupled to the processors. The program instructions may implement the functionality described herein (e.g., the functionality of various servers and other components that implement the network-based virtual computing resource provider described herein). The various methods as illustrated in the figures and described herein represent example embodiments of methods. The order of any method may be changed, and various elements may be added, reordered, combined, omitted, modified, etc.

Embodiments of monitoring time series model prediction performance as described herein may be executed on one or more computer systems, which may interact with various other devices. One such computer system is illustrated by FIG. 8. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing device, computing node, compute node, or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. Display(s) 1080 may include standard computer monitor(s) and/or other display systems, technologies or devices. In at least some implementations, the input/output devices 1050 may also include a touch- or multi-touch enabled device such as a pad or tablet via which a user enters input via a stylus-type device and/or one or more digits. In some embodiments, it is contemplated that embodiments may be implemented using a single instance of computer system 1000, while in other embodiments multiple such systems, or multiple nodes making up computer system 1000, may host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical techniques. For example, a graphics processor may implement a number of graphics primitive operations in a way that makes executing them much faster than drawing directly to the screen with a host central processing unit (CPU). In various embodiments, graphics rendering may, at least in part, be implemented by program instructions that execute on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above to implement monitoring time series model prediction performance are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a non-transitory, computer-readable storage medium may include storage media or memory media such as magnetic or optical media, e.g., disk or CD/DVD-ROM coupled to computer system 1000 via I/O interface 1030. Program instructions and data stored via a computer-readable medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 8, memory 1020 may include program instructions 1025, that implement the various methods and techniques as described herein, and data storage 1035, comprising various data accessible by program instructions 1025. In one embodiment, program instructions 1025 may include software elements of embodiments as described herein and as illustrated in the Figures. Data storage 1035 may include data that may be used in embodiments. In other embodiments, other or different software elements and data may be included.

Those skilled in the art will appreciate that computer system 1000 is merely illustrative and is not intended to limit the scope of the techniques as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a non-transitory, computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It is noted that any of the distributed system embodiments described herein, or any of their components, may be implemented as one or more web services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the web service in a manner prescribed by the description of the network-based service's interface. For example, the network-based service may describe various operations that other systems may invoke, and may describe a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a web services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, web services may be implemented using Representational State Transfer (“RESTful”) techniques rather than message-based techniques. For example, a web service implemented according to a RESTful technique may be invoked through parameters included within an HTTP method such as PUT, GET, or DELETE, rather than encapsulated within a SOAP message.

The various methods as illustrated in the FIGS. and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system, comprising:
at least one processor; and
a memory, storing program instructions that when executed by the at least one processor, cause the at least one processor to implement a time series forecasting system, configured to:
receive data to generate a new time series forecast;
determine that the data is associated with a previously generated time series forecast by a machine learning model;
determine that model monitoring is enabled for the machine learning model;
responsive to the determination that model monitoring is enabled for the machine learning model:
generate one or more performance metrics for the machine learning model according to a comparison of the data with the previously generated time series forecast; and
provide, via an interface of the time series forecasting system, the one or more performance metrics for the machine learning model.

2. The system of claim 1, wherein the time series forecasting system is further configured to:
detect an action event for the machine learning model based, at least in part, on the one or more performance metrics;
responsive to the detection of the action event:
identify a responsive action for the machine learning model according to the detected action event; and
cause performance of the responsive action for the machine learning model.

3. The system of claim 1, wherein to provide the one or more performance metrics for the machine learning model, the time series forecasting system is configured to generate and display a visualization of one of the one or more performance metrics.

4. The system of claim 1, wherein the time series forecasting system is a time series forecasting service implemented as part of a provider network, wherein the machine learning model is created in response to a request received at the time series forecasting service to create and host the machine learning model for generating one or more time series forecasts.

5. A method, comprising:
receiving, at a time series forecasting system, data to generate a new time series forecast;
determining, by the time series forecasting system, that the data is associated with a previously generated time series forecast by a machine learning model;
generating, by the time series forecasting system, one or more performance metrics for the machine learning model according to a comparison of the data with the previously generated time series forecast; and
providing, by an interface of the time series forecasting system, the one or more performance metrics for the machine learning model.

6. The method of claim 5, further comprising receiving a request, via the interface of the time series forecasting system to enable performance monitoring of the machine learning model, wherein the determining, the generating, and the providing are enabled for performance by the time series forecasting system responsive to the request to enable performance monitoring.

7. The method of claim 5, wherein the data is received to generate the new time series forecasting using a second machine learning model different than the machine learning model.

8. The method of claim 5, further comprising:
detecting, by the time series forecasting system, an action event for the machine learning model based, at least in part, on the one or more performance metrics;
responsive to detecting the action event:
identifying, by the time series forecasting system, a responsive action for the machine learning model according to the detected action event; and
causing, by the time series forecasting system, performance of the responsive action for the machine learning model.

9. The method of claim 8, wherein the responsive action is retraining the machine learning model based, at least in part, on the received data.

10. The method of claim 5, further comprising providing, via the interface of the time series forecasting system, a recommended action to perform for the machine learning model.

11. The method of claim 5, further comprising providing, via the interface of the time series forecasting system, a root cause explanation for the one or more performance metrics.

12. The method of claim 5, wherein one of the one or more performance metrics was defined analyzing performance of the machine learning model in a request received at the time series forecasting system.

13. The method of claim 5, wherein providing the one or more performance metrics for the machine learning model comprises generating and displaying a visualization of one of the one or more performance metrics.

14. One or more non-transitory, computer-readable storage media, storing program instructions that when executed on or across one or more computing devices cause the one or more computing devices to implement a time series forecasting system that implements:
receiving data to generate a new time series forecast;
automatically identifying a previously generated time series forecast by a machine learning model that is associated with the data;
generating one or more performance metrics for the machine learning model according to a comparison of the data with the previously generated time series forecast; and
providing, via an interface of the time series forecasting system, the one or more performance metrics for the machine learning model.

15. The one or more non-transitory, computer-readable storage media of claim 14, storing further program instructions that when executed on or across the one or more computing devices, cause the one or more computing devices to implement:
detecting an action event for the machine learning model based, at least in part, on the one or more performance metrics;
responsive to detecting the action event:
identifying a responsive action for the machine learning model according to the detected action event; and
causing performance of the responsive action for the machine learning model.

16. The one or more non-transitory, computer-readable storage media of claim 15, wherein the responsive action is sending an alert with respect to performance of the machine learning model.

17. The one or more non-transitory, computer-readable storage media of claim 14, storing further program instructions that when executed on or across the one or more computing devices, cause the one or more computing devices to implement providing, via the interface of the time series forecasting system, a recommended action to perform for the machine learning model.

18. The one or more non-transitory, computer-readable storage media of claim 14, storing further program instructions that when executed on or across the one or more computing devices, cause the one or more computing devices to implement providing, via the interface of the time series forecasting system, a root cause explanation for the one or more performance metrics.

19. The one or more non-transitory, computer-readable storage media of claim 14, wherein, in providing the one or more performance metrics for the machine learning model, the program instructions cause the one or more computing devices to implement generating and displaying a visualization of one of the one or more performance metrics.

20. The one or more non-transitory, computer-readable storage media of claim 14, wherein the time series forecasting system is implemented as part of an image or container for execution on a virtual compute system that is implemented as part of a provider network.
